(19) United States
(12) Patent Application Publication
(10) Pub. No.: US 2025/0176562 A1
(43) Pub. Date: Jun. 5, 2025

(54) FUNGICIDAL COMPOSITIONS COMPRISING ESSENTIAL OILS

(71) Applicant: YOUNG LIVING ESSENTIAL OILS, LC, Lehi, UT (US)

(72) Inventors: Richard E. Carlson, Sandy, UT (US); Tyler M. Wilson, South Jordan, UT (US)

(73) Assignee: YOUNG LIVING ESSENTIAL OILS, LC, Lehi, UT (US)

(21) Appl. No.: 18/527,179

(22) Filed: Dec. 1, 2023

(51) Int. Cl. A01N 65/44; A01N 65/10; A01N 65/22; A01N 65/24; A01N 65/28; A01P 3/00

(52) U.S. Cl. CPC A01N 65/44; A01N 65/10; A01N 65/22; A01N 65/24; A01N 65/28; A01P 3/00

(57) ABSTRACT

Compositions and methods for killing or inhibiting the growth of pathogenic fungi. A composition includes water, a solubilizer, and an essential oil extracted from one or more of lemongrass, cassia, eucalyptus, ajowan, clove leaf, or oregano.

### TECHNICAL FIELD

The disclosure relates generally to compositions and methods of preparation for fungicides comprising essential oils.

### BACKGROUND

Fungicides can play an important role in numerous sectors, and specifically in agriculture. Fungicides aid in the prevention and treatment of fungal diseases that can devastate crops and reduce yields. Additionally, fungicides can reduce food waste and ensure that crops reach the consumer market. Certain fungal diseases in crops can produce toxins that are harmful to humans and animals, and fungicides can control these fungal diseases to prevent the production of these toxins. Apart from crops, fungal diseases can also affect ornamental plants, trees, and turfgrass. Fungicides can play a role in ensuring the health and aesthetic value of these plants.

However, many traditional fungicides can lead to environmental contamination that impacts non-target organisms. Additionally, residues from traditional fungicides can remain on plant material that is later consumed by humans or animals. These residual fungicides can have significant health implications.

Thus, natural fungicides utilizing plant-based materials to kill or inhibit growth of pathogenic fungi are desired. In light of the foregoing, disclosed herein are compositions and methods of preparation for fungicides comprising plant-based materials.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic flow chart diagram of a method of preparing and applying a fungicidal composition comprising essential oils;

FIG. 2 is a schematic illustration of a process flow for extracting heavier lipid-soluble compounds from a plant material using an essential oil solvent;

FIG. 3 illustrates results of an in vitro study illustrating the efficacy of the fungicidal compositions described herein for killing or inhibiting the growth of pathogenic fungi;

FIG. 4 illustrates results of an in vitro study illustrating the efficacy of the fungicidal compositions described herein for killing or inhibiting the growth of pathogenic fungi; and

FIG. 5 is a schematic flow chart diagram of a method for preparing an essential oil-based fungicidal composition.

### DETAILED DESCRIPTION

Disclosed herein are fungicidal compositions and methods of making the same. Specifically disclosed herein are fungicidal compositions including one or more essential oils. The fungicidal compositions described herein are designed to kill or inhibit the growth of fungal pathogens. The compositions may be used for various applications, including agricultural, industrial, and medicinal use cases. The fungicidal compositions described herein are shown to exhibit unexpectedly good results in killing or inhibiting the growth of fungal pathogens known to attack plants.

Fungi can have a variety of impacts on plants, ranging from beneficial to detrimental. The fungicidal compositions described herein are designed to kill or inhibit the grown of fungi that exhibit detrimental impacts on plant life. Many fungi are pathogenic to plants and may cause a wide range of diseases. The diseases may manifest with leaf spots, wilts, blight, rusts, root rots, molds, and mildews. Some fungal pathogens produce toxins that are harmful to the plant and, if consumed, can be toxic to animals and humans as well. Chronic fungal infections can reduce the growth, vigor, and yield of an infected plant, even if the fungal infection does not kill the plant. In some cases, invasive fungal pathogens can drastically alter ecosystem dynamics. Thus, it is desirable to reduce the presence of pathogenic fungi.

However, most traditional fungicides are associated with numerous environmental and health drawbacks. Traditional fungicides can persist in the environment and may contaminate soil and water sources. These can introduce adverse effects on non-target organisms, including beneficial insects, aquatic life, and birds. Additionally, exposure to certain traditional fungicides can pose risks to human health. Some traditional fungicides have been linked to skin irritation, respiratory problems, and long-term health issues such as cancer and endocrine disruption. Residual amounts of traditional fungicides on crops can make their way into the human food chain, and consuming these residues can lead to potential health risks over time. By affecting a broad range of fungi, traditional fungicides can inadvertently change the composition and function of fungal communities in an ecosystem, which may introduce long-term ecological consequences. Additionally, some traditional fungicides can cause damage to the plants they are intended to protect, and particularly when applied under unfavorable conditions or at inappropriate doses. Given these drawbacks associated with traditional fungicides, described herein are fungicidal compositions comprising one or more essential oils. The essential oil-based compositions described herein exhibit unexpectedly good results in killing or halting the growth of pathogenic fungi while reducing the environmental and health costs.

Essential oils are volatile, aromatic compounds extracted from plants. They are called “essential” because they capture the “essence” or unique scent and flavor of the plant from which they are derived. The essential oils utilized in the fungicidal compositions described herein may be extracted using one or more extraction processes. The extraction processes include retrieving raw plant material, such as flowers, leaves, wood, bark, roots, seeds, or peel. The raw plant material undergoes an extraction process such as solvent-based extraction, steam distillation, hydro-distillation, carbon dioxide extraction, maceration, enfleurage, cold press extraction, water distillation, or other means. The extraction process is typically selected based on the delicacies, boiling point, and other physical and biological characteristics of the plant that the essential oil is being extracted from.

In many cases, the raw plant materials are processed using steam distillation or hydro distillation. Steam distillation includes disposing the raw plant materials into an alembic (distillation apparatus) over water. As the water is heated, the steam passes through the plant material and vaporizes the volatile compounds. Hydro-distillation includes immersing the plant materials into water and vaporizing the water. When the water vaporizes, volatile compounds are extracted from the plant material. When the water vapor cools through a cooling coil or other condenser, the volatile compounds to a liquid state, which is then collected in the receiving vessel.

In some cases, plant-based extracts are extracted using solvent extraction. Some flowers contain too little volatile oil to undergo expression, and/or their chemical components are too delicate and easily denatured by the high heat used in steam distillation. In these cases, a solvent such as hexane or supercritical carbon dioxide is used to extract the oils. Extracts from hexane and other hydrophobic solvents are called concretes, which are a mixture of essential oil, waxes, resins, and other lipophilic plant material. Although highly fragrant, concretes include large quantities of non-fragrant waxes and resins. Often, another solvent, such as ethyl alcohol, is used to extract the fragrant oil from the concrete. The alcohol solution is chilled at an ultracold temperature, which causes the waxes and lipids to precipitate out. The precipitates are then filtered out and the ethanol is removed from the remaining solution by evaporation, vacuum purge, or both, leaving behind the absolute.

Carbon dioxide is used as a solvent in supercritical fluid extraction. This method can avoid petrochemical residues in the product from solvent extractions, or the loss of some components when steam distillation is used. Supercritical carbon dioxide does not yield an absolute directly. The supercritical carbon dioxide will extract both the waxes and the essential oils that make up the concrete. Subsequent processing with liquid carbon dioxide, achieved in the same extractor by merely lowering the extraction temperature, will separate the waxes from the essential oils. This lower temperature process prevents the decomposition and denaturing of compounds. When the extraction is complete, the pressure is reduced to ambient, and the carbon dioxide reverts to a gas.

Before the compositions and methods for essential oil-based fungicides are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified ingredients, materials, or steps and those that do not materially affect the basic and novel characteristic or characteristics of the claimed disclosure.

As used herein, “effective amount” means an amount of an ingredient or a component of the product that is nontoxic, but sufficient to provide the desired effect and performance at a reasonable benefit/risk ratio attending any dietary supplement or product. For example, an effective amount of a vitamin or mineral is an amount sufficient to prevent a deficiency thereof and to reduce the incidence of some adverse effects.

As used herein, a component or ingredient of a composition may include any suitable form of the component or ingredient, such as, for example, an extract, a powder, a tincture, an absolute, an essential oil, a paste, a dehydrated form, and so forth. It should be appreciated that any suitable form or combination of a component or ingredient may be used unless otherwise specified.

As used herein, an “extract” includes any substance obtained from a raw material. An extract may be obtained from a blossom, fruit, root, whole plant, leaf, or other component of an agricultural or horticultural component. An extraction may be obtained through expression, absorption, maceration, distillation, grinding, dehydration, and so forth. An extract may be stored in a solvent such as ethanol or water or may be stored in a dry form such as a powder.

As used herein, an “essential oil” is a lipid-soluble compound derived from a plant material. The essential oil may specifically include volatile or aromatic chemical compounds extracted from the plant material. Essential oils may be extracted using steam distillation, hydro-distillation, expression, solvent extraction, absolute oil extraction, resin tapping, wax embedding, cold pressing, carbon dioxide extraction, enfleurage, and other extraction means. Essential oils may include one or more terpenes and may specifically include one or more monoterpenes and sesquiterpenes.

Essential oils that may be utilized in the fungicidal compositions described herein include, but are not limited to, oils extracted from ajowan, basil, bergamot, black pepper, black seed, black spruce, blue cypress, blue spruce, blue tansy, blue yarrow, cassia, fleabane, cannabis, cardamom, carrot seed, cedarwood, chamomile, cinnamon bark, cistus, citronella, clary sage, clove, copaiba, cypress, davana, dorado azul, elemi, eucalyptus, fennel, frankincense, geranium, ginger, goldenrod, grapefruit, helichrysum, hinoki, hong kuai, hyssop, lemon, jasmine, juniper, kunzea, lavender, ledum, lemon, lemon myrtle, lemon verbena, lemongrass, lime, mugwort, manuka, marjoram, mastrante, melaleuca, myrrh, myrtle, neroli, nutmeg, Ocotea, orange, oregano, palmarosa, palo santo, patchouli, peppermint, petitgrain, pine, ravintsara, rose, rosemary, sandalwood, shell ginger, rue, sage, spearmint, tangerine, tea tree, thyme, tsuga, turmeric, valerian, vanilla, vetiver, wintergreen, xiang mao, and ylang ylang.

In some cases, an essential oil does not include carrier oils. Common carrier oils include, for example, sweet almond oil, coconut oil, olive oil, sesame oil, jojoba oil, grapeseed oil, vegetable oil, and hemp oil.

Unless defined otherwise, all technical and scientific terms used herein have the same meanings as commonly understood by one of ordinary skill in the art to which this disclosure pertains and belongs.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

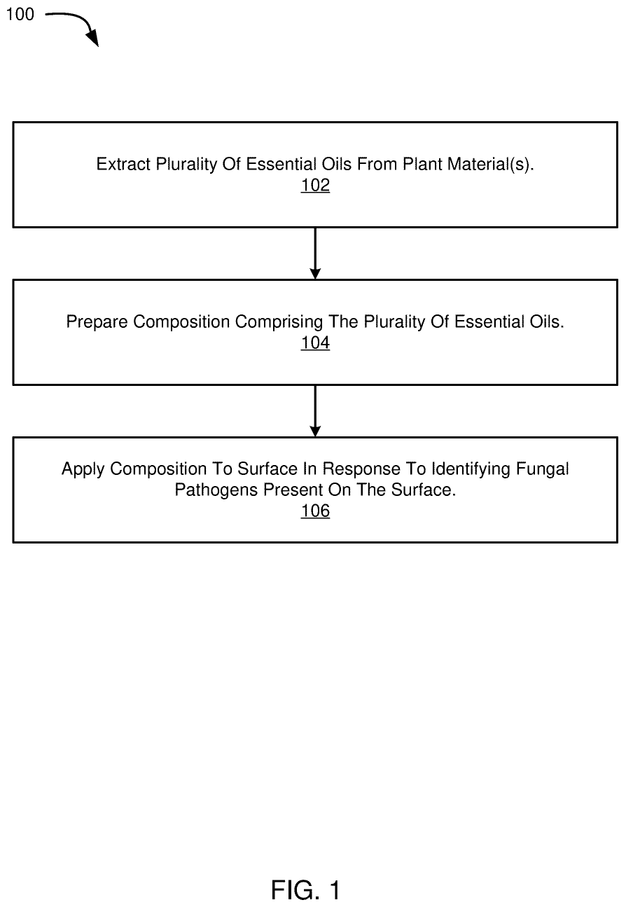

Referring now to the figures, FIG. 1 is a schematic flow chart diagram of a method 100 for preparing and applying an essential oil-based fungicidal composition. Fungicides are a necessary tool for largescale agriculture. However, traditional fungicides are often detrimental to the surrounding environment and are known to contaminate water systems. The essential oil fungicides described herein comprise active ingredients that can be used in pesticides products and are exempt from some government regulation applicable to insecticides, fungicides, and rodenticides. The active ingredients included in the compositions described herein are naturally released to the environment by various plants and are considered biodegradable and non-contaminating.

The method 100 includes extracting at 102 a plurality of essential oils from one or more raw plant materials. The method 100 includes preparing at 104 a composition comprising the plurality of essential oils. The method 100 includes applying at 106 the composition to a surface of a plant or other material, in response to identifying fungal pathogens present on the surface.

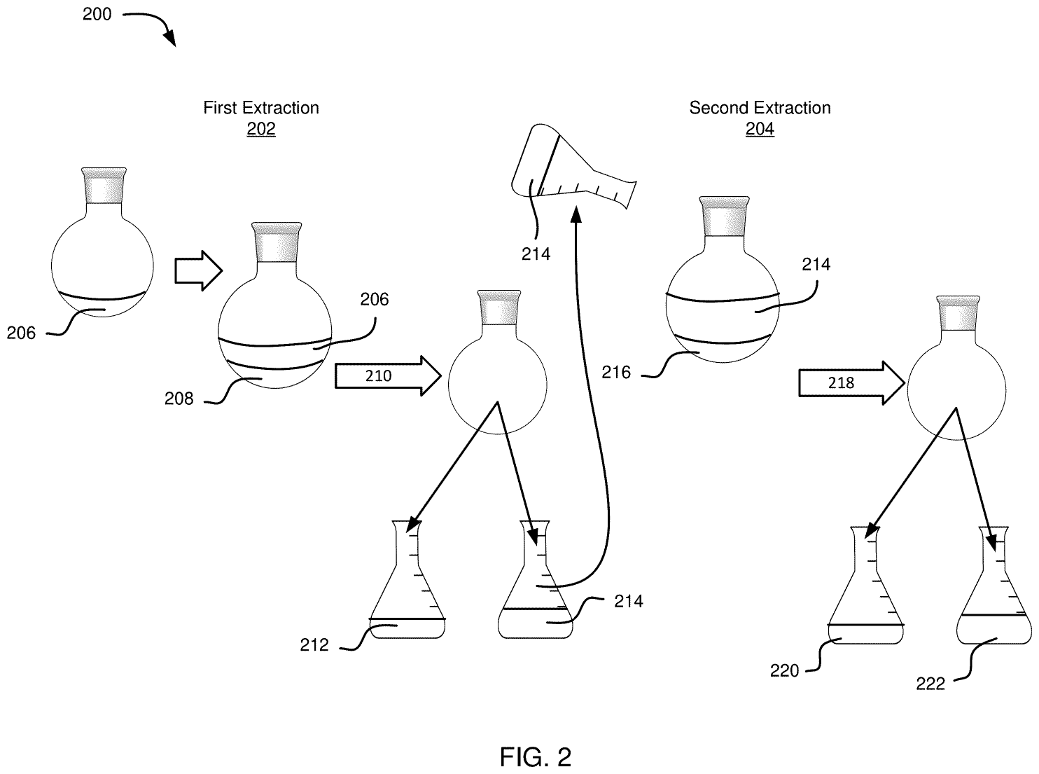

The extracting 102 may include one or more extraction processes. The extracting 102 may include any known extraction process for essential oils and may specifically include one or more of solvent-based extraction, steam distillation, hydro-distillation, carbon dioxide extraction, maceration, enfleurage, cold press extraction, water distillation, or other means. In some cases, the composition includes an essential oil with a relatively heavy molecular weight, and in these cases, the extracting 102 may include the multiple step extraction method 200 described in FIG. 2.

The raw plant material may include any number of raw plant materials such as leaves, petals, stems, seeds, roots, bark, woods, resin, and so forth. The raw plant material includes any suitable plant material comprising an essential oil that may be extracted and used as the essential oil solvent 214. The raw plant material may include, for example: plants from the carrot family such as anise, dill, or angelica; plants from the ginger family such as cardamom and ginger; plants from the laurel family such as cinnamon and camphor; plants from the mint family such as peppermint, rosemary, or thyme; plants from the myrtle family such as clove or allspice; plants from the orchid family such as vanilla; plants from the nutmeg family such as nutmeg or mace; and plants from the pepper family such as black pepper.

The raw plant material may include seeds or other components of vegetables or fruits. The raw plant material may include edible or non-edible plant materials that comprise one or more edible or non-edible oils. The raw plant material may include leaves from one or more varieties of plants, such as ajowan, bay, bay laurel, black spruce, cassia, mint, cajeput, cinnamon, eucalyptus, geranium, kanuka, lemon myrtle, manuka, myrtle, niaouli, patchouli, petitgrain, Ravensara, saro, tea tree, tobacco, or violet. The raw plant material may include one or more components of flowering herbs such as basil, catnip, clary sage, green tea, holy basil, hyssop, lavender, lavandin, lemon balm, marjoram, oregano, peppermint, rosemary, sage, spearmint, thyme, or yarrow. The raw plant material may include flowers, petals, or buds from various plants such as boronia, Cananga, chamomile, clove, davana, helichrysum, jasmine, linden blossom, neroli, rose, tagetes, tuberose, or ylang ylang. The raw plant material may include woods such as wood from amyris, cedarwood, palo santo, rosewood, or sandalwood. The raw plant material may include other plant components such as bark, needles, grass, resin, balsam, gum, berries, fruit, citrus rinds, roots, or seeds. The raw plant material may be derived from, for example, cassia, cinnamon, cannabis, cypress, fir, scotch pine, spruce, citronella, lemongrass, palmarosa, benzoin, peru balsam, elemi, frankincense, galbanum, gurjum, myrrh, allspice, black pepper, juniper berry, may chang, bergamot, grapefruit, lemon, lime, mandarin, orange, tangerine, yuzu, angelica, ginger, spikenard, vetiver, ambrette, anise, cacao, cardmon, carrot, coffee bean, coriander, cumin, dill, fennel, nutmeg, parsley, oakmoss, and so forth.

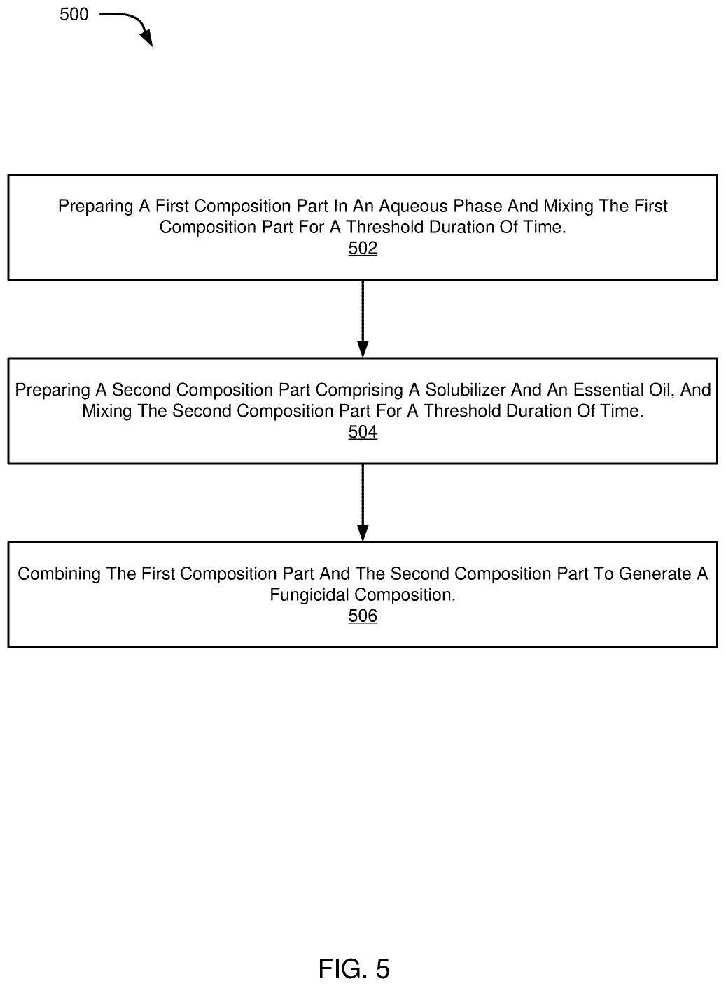

The preparing 104 may be performed according to the method 500 described in FIG. 5. Specifically, the preparing 104 may include mixing a plurality of essential oils derived from a plurality of raw plant materials. The plurality of essential oils may be mixed with additional ingredients to prepare a fungicidal composition. The additional ingredients may include one or more of water, a saponin, a solubilizer, glycerin, and additional plant materials or plant extracts.

In some cases, the fungicidal composition includes a saponin such as bio saponin. Saponins are a class of chemical compounds found in various plant species. Saponins are glycosides with a non-sugar component composed of a steroid or triterpene.

In some cases, the fungicidal composition includes a solubilizer. The solubilizer is a compound that aids in enabling one substance to dissolve into another, even when the two substances normally do not mix well. In the fungicidal composition, the solubilizer aids in dissolving the essential oils into the water solvent. In some cases, this results in a clear or transparent solution. However, this is not always the case, and the solution may be cloudy. The amount or type of solubilizer may be optimized such that the solution does not exhibit a visible separation between aqueous and water phases in the formulation. The solubilizer may include one or more of a polysorbate, polyethylene glycol ester, or cyclodextrin, surfactant, or any other suitable solubilizer.

The preparing 104 may additionally include preparing the fungicidal composition for application as a foliar spray. Foliar spraying refers to the technique of applying liquid nutrients or other substances directly to the leaves of plants. When the fungicidal composition is applied as a foliar spray, the active ingredients of the composition are capable of directly attacking pathogenic fungi residing on an exterior of the plant. When applied as a foliar spray, certain components of the fungicidal composition may additionally be absorbed by the plant through the leaves.

The applying 106 may include spraying the fungicidal composition on to the leaves of plants as a foliar spray. This enables the active ingredients of the fungicidal composition to immediately begin killing or inhibiting the growth of pathogenic fungi residing on the leaves or stems of the plant. This enables the fungicidal composition to bypass soil issues or soil specifications that could be detrimental to the efficacy of the essential oils within the composition.

FIG. 2 is a schematic illustration of a method 200 for extracting heavy lipid-soluble molecules with an essential oil solvent. In some cases, the essential oil-based fungicidal compositions described herein include an essential oil with a relatively heavy molecular weight. In these cases, the relatively heavy essential oil may be extracted using the multiple step extraction method 200. However, not all essential oils of the fungicidal composition need be extracted using the method 200 and may be extracted using known extraction methods such as one or more of steam distillation, hydro-distillation, solvent-based extraction, carbon dioxide extraction, enfleurage, or cold-press extraction.

It should be understood that the illustration in FIG. 2 is merely a schematic drawing, such that relative densities, viscosities, and solubilities of various components may not be accurate in all implementations. The method 200 may specifically be implemented to extract one or more molecules that cannot be effectively extracted using traditional means due to having a higher molecular weight. The method 200 may be performed in connection with other extraction methods, including solvent extraction and distillation.

The method 200 includes a first extraction 202 and a second extraction 204. The first extraction 202 is performed to retrieve the solvent that will be used for the second extraction 204. The first extraction 202 includes disposing a first solvent 206 and a first plant material 208 into a vessel. The first extraction 202 includes performing one or more first extraction steps 210. The first extraction 202 results in retrieving a first byproduct 212 and an essential oil solvent 214. The byproduct 212 may be discarded, used, or implemented in further extraction processes. The essential oil solvent 214 comprises one or more molecules extracted from the first plant material 208. The first plant material 208 may include any of the raw plant materials discussed in connection with FIG. 1.

In an implementation, the first extraction 202 is a solvent extraction process. In this implementation, the first solvent 206 includes a solvent such as ethanol, benzene, dimethyl ether, ethyl acetate, methanol, or hexane to isolate the oils within the first plant material 208. This solvent extraction process may be selected based on the delicacy of the first plant material 208 and whether the first plant material 208 is able to withstand other extraction methods such as steam distillation.

In another implementation, the first extraction 202 is not a solvent-based extraction process, and instead includes a steam distillation extraction process, wherein the first plant material 208 is extracted by passing hot steam through the first plant material 208 to vaporize one or more volatile compounds within the first plant material 208. In many cases, steam distillation is a desirable extraction process because the resultant extracted compounds are highly pure and may be safe for human use and consumption.

In another implementation, the first extraction 202 includes a carbon dioxide extraction process. Carbon dioxide extraction uses carbon dioxide as the first solvent 206. The process of carbon dioxide extraction begins by pressuring the carbon dioxide until it liquifies. The liquid carbon dioxide is used as the first solvent 206 to extract oils from the first plant material 208. When the carbon dioxide extraction is complete, the extract is returned to atmospheric pressure, which causes the carbon dioxide to revert into a gas. At room temperature and pressure, carbon dioxide itself is colorless, odorless, flavorless, and non-toxic, but carbon dioxide extraction processes may not result in the most desirable essential oil product. Because carbon dioxide extraction takes place in a sealed chamber, it recovers the whole carbon dioxide-soluble portion from the first plant material 208, including any additional compounds that are present in the plant material. In some cases, these additional compounds may be unwanted and require removal by additional processing.

In another implementation, the first extraction 202 includes an enfleurage extraction process. Enfleurage is a process that uses fats that are solid at room temperature to capture essential oils within plant material. Enfleurage may be implemented as “cold” enfleurage or “hot” enfleurage. In cold enfleurage, a large plate or series of fine mesh screens are smeared with a layer of fat and allowed to set. Plant material is then placed on the fat and the essential oils within the plant material are allowed to diffuse into the fat over the course of one or more days. The process may be repeated by replacing the plant material until the fat has reached a desired degree of essential oil saturation. In hot enfleurage, solid fats are heated, and plant material is stirred into the fat. Spent plant material is repeatedly strained from the fat and replaced with raw plant material until the fat is sufficiently saturated with essential oils.

In another implementation, the first extraction 202 includes a cold-press extraction process, which may alternatively be referred to as “expression.” Cold-press extraction may specifically be used to isolate oils from citrus peels. The cold-press extraction process includes puncturing the first plant material 208 to rupture oil sacs within the first plant material 208. When this occurs, the essential oils from the first plant material 208 may run down into a collection area. The first plant material 208 may then be mechanically pressed to squeeze out the remaining oils and juices. The resulting oils and juices will include solid elements which may be separated from the liquids. The oils will separate from the juice layer to create the final essential oil product, which is used as the essential oil solvent 214 in the second extraction 204.

In another implementation, the first extraction 202 includes extraction protocols that use hydro-distillation. Hydro-distillation uses plant materials packed in a still compartment soaked in water, which is then steamed or boiled in the entire pot to extract oil and bioactive compounds from the water. The vapor mixture of water and oil is condensed by indirect cooling with water. The condensed mixture flows from a condenser to a separator, where oil and hydrophobic bioactive compounds are separated automatically from the water.

It should be understood that in some cases, the process of extracting 102 as discussed in connection with FIG. 1 will not include the two-step extraction method 200 described in FIG. 2. In these cases, the process of extracting 102 might include only the first extraction 202 process described in connection with FIG. 2.

The second extraction 204 includes disposing the essential oil solvent 214 and a second plant material 216 in a vessel. The second extraction 204 includes performing one or more second extraction steps 218. The second extraction 204 results in retrieving a second byproduct 220 and a heavy molecule composition 222.

In the event the first extraction 202 is a solvent-based extraction process, the first solvent 206 may include a solvent such that the resulting essential oil solvent 214 does not include harmful chemicals that may deteriorate the quality of the resulting heavy molecule composition 222. The first solvent 206 may specifically include a polar solvent such as methanol, ethanol, or acetone. The first solvent 206 may include an organic solvent with low polarity such as hexanes, toluene, dichloromethane, or diethyl ether.

The first extraction steps 210 are dependent on the methods implemented for the first extraction 202. In an implementation, the first extraction 202 is a solvent-based extraction as shown in FIG. 2. Solvent extraction is a process in which compounds are separated based on their relative solubilities. Solvent extraction involves using a solvent (i.e., the first solvent 206), which is a fluid having the ability to dissolve another substance. Then first solvent 206 may be disposed in the solid, liquid, or gas state. The first solvent's 206 molecules pull apart the solute's molecules (in this case, the molecules of the first plant material 208), and eventually the solute's molecules become evenly distributed throughout the solvent. The first solvent 206 and one or more compounds from the first plant material 208 may form two or more immiscible phases (i.e., two or more fluids that do not dissolve in one another). The two or more immiscible phases may separate because the layers differ in polarity or orientation. The order of the phases and determination of whether a particular fluid is on top or on the bottom is determined by the relative densities of the fluids.

In a solvent-based extraction method, the first extraction steps 210 may include applying kinetic energy to the composition by way of shaking, stirring, microwave energy, or sonication. The first extraction steps 210 may additionally include applying electromagnetic energy sonic wave or heat to the composition by way of light emissions or a heat source. This may prompt the first solvent 206 to extract one or more molecules from the first plant material 208.

The byproduct 212 may include one or more of the first solvent 206 or components left over from the first plant material 208. The byproduct 212 may include a mixture of solid and liquid components. The essential oil solvent 214 includes one or more essential oils and other compounds extracted from the first plant material 208. The essential oil solvent 214 may specifically include one or more terpenes or terpenoids present in the first plant material 208.

The essential oil solvent 214 includes purified essential oils extracted from the first plant material 208. These extracted essential oils are then used as the solvent for the second extraction 204. Thus, the essential oils from the first plant material 208 are used as a solvent to extract molecules from the second plant material 216. In contrast with traditional solvent-based extraction methods, the essential oil solvent 214 is not discarded or burned off as a byproduct. In these traditional methods, the solvent is often toxic when ingested. This presents numerous issues, particularly because trace amounts of the solvent will typically remain in the resultant solution, and further because the solvent byproduct presents numerous environmental concerns. By contrast, in the methods described herein, the essential oil solvent 214 is saved and may remain in the heavy molecule composition 222 in combination with one or more essential oils or heavy molecules that are extracted from the second plant material 216.

The compounds having a “heavier molecular weight” comprise a molecular weight that exceeds a mass threshold for extracting the compound by traditional extraction or distillation methods. The heavier molecular weight prevents the compound from being extracted from a plant material through one or more of steam distillation, hydro-distillation, carbon dioxide extraction, enfleurage, cold-press extraction, or traditional solvent-based extraction methods. The traditional solvent-based extraction methods implement a solvent that is removed following the extraction process. Traditional solvent-based extraction methods may implement a solvent comprising, for example, methanol, ethanol, acetone, hexanes, toluene, dichloromethane, diethyl ether, and so forth.

The second extraction steps 218 are implemented to aid the essential oil solvent 214 in extracting one or more heavy compounds from the second plant material 216. The second extraction steps 218 include weighing out a desired quantity of the essential oil solvent 214 and disposing the same into a reaction vessel. The second extraction steps 218 including weighing out a desired quantity of the second plant material 216 or spent biomass (i.e., spent plant material) that has previously been processed for extraction. The second plant material 216 may be ground into a fine powder and then disposed in the reaction vessel along with the essential oil solvent 214. The ratio of the essential oil solvent 214 to the second plant material 216 is optimized for extracting heavy compounds from the second plant material 216. The solution within the reaction vessel may include from about 20 wt. % to about 55 wt. % of the essential oil solvent 214, and from about 35 wt. % to about 60 wt. % of the plant material. It should be appreciated that the relative quantities of the essential oil solvent 214 and the plant material 216 will be optimized and adjusted depending on the procedures being followed in the second extraction steps 218 and/or the identity of the compounds within the solution.

The second extraction steps 218 may include one or more steps for introducing energy into the reaction vessel. The second extraction steps 218 may include heating the solution. The reaction temperature may be selected and optimized based on the identity of the compounds within the solution, and specifically based on whether the compounds in the solution are prone to breaking down or becoming inactivated in the presence of heat. The second extraction steps 218 may include introducing kinetic energy into the solution by way of sonication, agitating the solution, introducing microwave energy, stirring the solution, and so forth.

The solution comprising the essential oil solvent 214 and the plant material 216 may become a slurry mixture. After the solution is agitated and/or allowed to rest for a sufficient amount of time such that the essential oil solvent 214 has extracted at least a portion of the compounds within the second plant material 216, then the slurry mixture may be filtered to remove fine particles and other solids that remain from the second plant material 216. The slurry mixture may be filtered through an ultrafine filter, such as a 20-micron to 60-micron pore size filter.

The method 200 will extract heavy compounds from the second plant material 216.

These heavy compounds may include heavier terpenes or terpenoids such as triterpenes or triterpenoids. Additionally, these heavier compounds may include vitamins, carotenoids, flavonoids, phenolic acids, stilbenes, and others. The essential oil solvent 214 is specifically implemented to extract lipid-soluble and biologically active compounds with a molecular weight that exceeds a traditional extraction threshold.

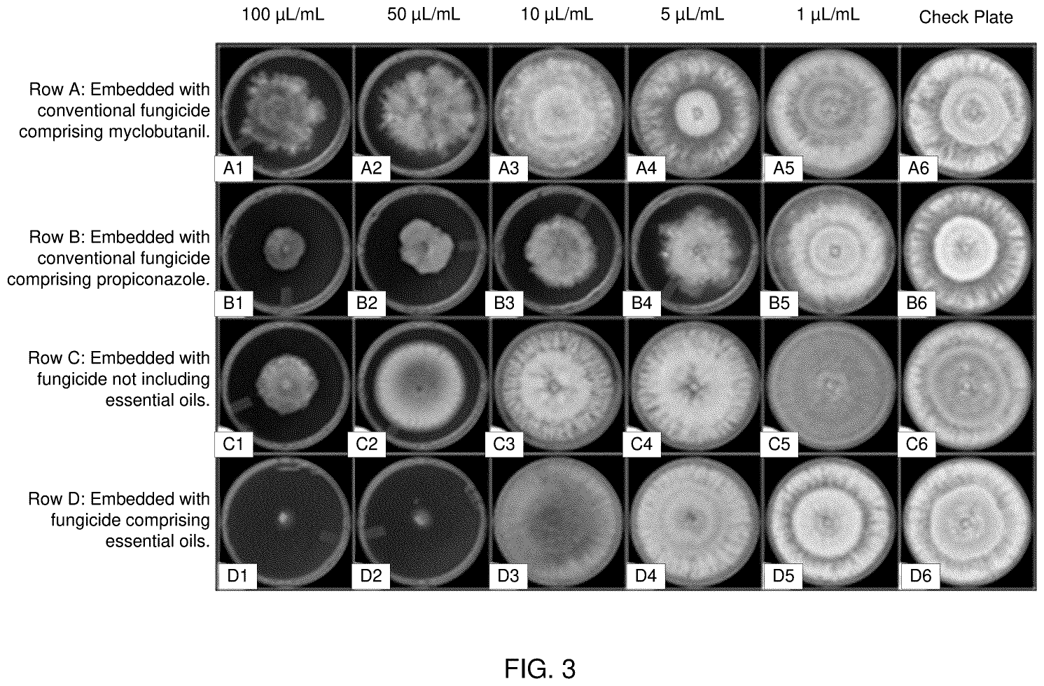

FIG. 3 illustrates results from an in vitro study testing the effectiveness of an essential oil-based fungicidal composition as described herein. The composition was tested against the fungal pathogen referred to as grey mold (Botrytis cinerea).

FIG. 3 illustrates the results from a traditional non-essential oil fungicide at rows A and B. FIG. 3 further illustrates the results from the essential oil-based fungicidal composition described herein at rows C and D. The traditional fungicide and the essential oil composition were embedded into potato dextrose agar plates prior to cooling and solidifying the plates. A colony of grey mold (5 mm×5 mm) was placed in the center of each plate and allowed to grow for a seven-day period.

In the results illustrated in FIG. 3, row A, which includes A1, A2, A3, A4, A5, and A6, represents six different samples embedded with a conventional fungicide having an active ingredient(s) including myclobutanil, wherein each sample is embedded with the conventional fungicide at a different concentration. Row B, which includes B1, B2, B3, B4, B5, and B6, represents six different samples embedded with a conventional fungicide having an active ingredient(s) including propiconazole, wherein each sample is embedded with the conventional fungicide at a different concentration. Row C, which includes C1, C2, C3, C4, C5, and C6, represents six different samples embedded with a fungicide that does not include essential oils, wherein each sample is embedded with the fungicide at a different concentration. Row D, which includes D1, D2, D3, D4, D5, and D6, represents six different samples embedded with a fungicide that includes at least one essential oil, wherein each sample is embedded with the essential oil fungicide at a different concentration. The samples illustrated in row D are specifically embedded with the essential oil fungicidal composition that is described herein.

All pictures depicted in FIG. 3 were captured after seven days (168 hours) from inoculation. Prior to inoculating the petri dishes, the nutrient agar (PDA) was embedded with the various fungicides at different compositions. The samples illustrated in column one, including A1, B1, C1, and D1, were embedded with their respective fungicides at 100 μL/mL. The samples illustrated in column two, including A2, B2, C2, and D2, were embedded with their respective fungicides at 50 μL/mL. The samples illustrated in column three, including A3, B3, C3, and D3, were embedded with their respective fungicides at 10 μL/mL. The samples illustrated in column four, including A4, B4, C4, and D4, were embedded with their respective fungicides at 5 μL/mL. The samples illustrated in column five, including A5, B5, C5, and D5, were embedded with their respective fungicides at 1 μL/mL. The samples illustrated in column six, including A6, B6, C6, and D6, represent a check plate that were not embedded with any fungicidal composition.

The results depicted in FIG. 3 demonstrate the efficacy of the essential oil-based fungicidal composition that is described herein. The essential oil-based fungicidal composition described herein exhibits similar or better efficacy when compared to conventional fungicides at the same concentration. Additionally, the study indicates that the essential oil blend serves as the primary active ingredient within the fungicidal composition described herein.

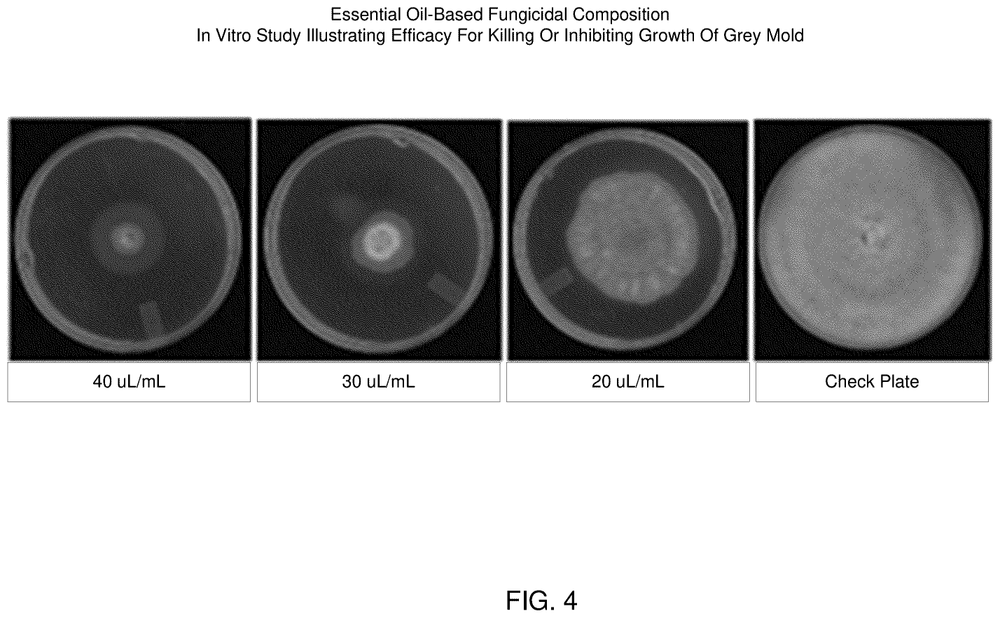

FIG. 4 illustrates results from an in vitro study testing the effectiveness of an essential oil-based fungicidal composition as described herein. The composition was tested against the fungal pathogen referred to as grey mold (Botrytis cinerea). The results illustrated in FIG. 4 represent a follow-up to the results illustrated in FIG. 3.

In FIG. 3, there is a significant change between the results illustrated in D2 (i.e., the essential oil-based fungicidal composition at 50 μL/mL) and the results illustrated in D3 (i.e., the essential oil-based fungicidal composition at 10 μL/mL). The study illustrated in FIG. 4 investigates the significant difference between D2 and D3 (of FIG. 3) by testing additional incremental concentrations. The results illustrated in FIG. 4 demonstrate that 40 μL/mL and 30 μL/mL concentrations exhibit good efficacy. Notably, the 40 μL/mL and 30 μL/mL concentrations are lower than the optimal concentration for a conventional fungicide. This indicates that the essential-oil based fungicidal composition demonstrates unexpectedly good results even when compared against conventional fungicides.

In the study, the essential oil fungicidal composition described herein was embedded into potato dextrose agar plates prior to cooling and solidifying the plates. A colony of grey mold (5 mm×5 mm) was placed in the center of each plate and allowed to grow for a seven-day period. Each of the images in FIG. 4 show the results after seven days of growth. As shown in FIG. 4, the plate with the highest concentration of the fungicidal composition (i.e., 40 μL/mL) exhibited the best results, and the next best results were obtained from the second highest concentration at 30 μL/mL. The next best results were obtained from the least concentrated at 20 μL/mL. As shown in FIG. 4, the check plate with no addition showed substantial growth of grey mold.

When considering the data from the second in vitro study illustrated in FIG. 4, the essential oil-based fungicidal composition described herein is as effective or more effective than conventional fungicides. The essential-oil based fungicidal composition is effective even at a concentration 30 μL/mL. This is particularly notable when considering that conventional fungicides are deemed effective at a concentration of 100 μL/mL or more. Thus, the essential-oil based fungicidal composition described herein is significantly more effective than conventional fungicides and does not require the same concentration levels as conventional fungicides to exhibit similar efficacies. The fungicidal compositions described herein are effective even with active ingredients ranging from about 0.25 wt. % to about 2 wt. % of the total composition.

The fungicidal compositions described herein exhibit unexpectedly good results in killing or inhibiting the growth of a fungicidal pathogen. In some cases, the fungicidal compositions described herein may be applied as a broad-spectrum treatments for fungicidal pathogens.

The composition may specifically include one or more of the essential oils in Table 1.

TABLE 1

| Plant Common | Plant Scientific | Compound(s)/Active |
|---|---|---|
| Name | Name | Ingredient(s) |
| Lemongrass | Cymbopogon flexuosus | Neral, Geranial |
| Cassia | Cinnamomum cassia | (E)-cinnamaldehyde |
| Eucalyptus | Eucalyptus globulus | 1,8-cineole |
| Ajowan | Trachyspermum ammi | p-Cymene, γ-Terpinene, Thymol |
| Clove Leaf | Syzygium aromaticum | Eugenol |
| Oregano | Origanum vulgare | Carvacrol |

The compositions may include active ingredients extracted from one or more of the essential oils described in Table 1. The compositions may additionally or alternatively comprise active ingredients extracted from other sources. For example, the neral and/or the geranial may alternatively or additionally be extracted from one or more of Litsea cubeba, lemon myrtle (Backhousia citriodora), lemon tea-tree (Leptospermum liversidgei), Ocimum gratissimum, Litsea citrate, or Calypranthes parriculata. Further for example, the (E)-cinnamaldehyde may alternatively or additionally be extracted from one or more of cinnamon bark (Cinnamomum verum), or other Cinnamomum spp. Further for example, the 1,8-cineole may alternatively or additionally be extracted from one or more of various Eucalyptus spp., tea tree (Melaleuca alternifolia), or rosemary (Salvia Rosmarinus). Further for example, the p-Cymene, γ-Terpinene, and/or Thymol may alternatively or additionally be extracted from one or more of Thymus vulgaris, Thymus zygis, or Ocimum gratissimum. Further for example, the eugenol may alternatively or additionally be extracted from one or more of cinnamon leaf (Cinnamomum verum), sweet basil (Ocimum basilicum), Ocimum gratissimum, or Laurus nobilis. Further for example, the carvacrol may alternatively or additionally be extracted from one or more of various Origanum spp., Plectranthus amboinicus, and various Satureja spp.

In an implementation, the composition includes the following as shown in Table 2.

TABLE 2

| | Weight Percentage Total |
|---|---|
| Component | Composition (wt. %) |
| Water | 76 |
| Bio saponin | 1 |
| Pinna Leaf | 2.5 |
| Ethanol | 9 |
| Essential oil blend | 2 |
| Glycerin | 4.5 |
| Symbiosolv | 5 |

In an implementation, the composition includes the following as shown in Table 3.

TABLE 3

| | Weight Percentage Total |
|---|---|
| Component | Composition (wt. %) |
| Water | 85 |
| Bio saponin | 0.25 |
| Pinna Leaf | 2.25 |
| Ethanol | 5 |
| Essential oil blend | 1 |
| Glycerin | 2.5 |
| Symbiosolv | 4 |

In an implementation, the composition includes the following as shown in Table 4.

TABLE 4

| | Weight Percentage Total |
|---|---|
| Component | Composition (wt. %) |
| Water | 90 |
| Bio saponin | 0.25 |
| Pinna Leaf | 2.25 |
| Essential oil blend | 1 |
| Glycerin | 2.5 |
| Symbiosolv | 4 |

In an implementation, the composition includes the following as shown in Table 5.

TABLE 5

| | Weight Percentage Total |
|---|---|
| Component | Composition (wt. %) |
| Water | 85 |
| Bio saponin | 0.25 |
| Pinna Leaf | 2.25 |
| Ethanol | 6 |
| Essential oil blend | 1 |
| Glycerin | 2.5 |
| Symbiosolv | 3 |

In an implementation, the composition includes the following as shown in Table 6.

TABLE 6

| | Weight Percentage Total |
|---|---|
| Component | Composition (wt. %) |
| Water | 80 |
| Bio saponin | 0.25 |
| Pinna Leaf | 1.75 |
| Ethanol | 12 |
| Essential oil blend | 1 |
| Glycerin | 3 |
| Symbiosolv | 2 |

In an implementation, the composition includes the following as shown in Table 7.

TABLE 7

| | Weight Percentage Total |
|---|---|
| Component | Composition (wt. %) |
| Water | 85 |
| Bio saponin | 0.1 |
| Pinna Leaf | 1.9 |
| Ethanol | 6 |
| Essential oil blend | 1 |
| Glycerin | 2.5 |
| Symbiosolv | 3.5 |

In an implementation, the composition includes the following as shown in Table 8.

TABLE 8

| | Weight Percentage Total |
|---|---|
| Component | Composition (wt. %) |
| Water | 85 |
| Bio saponin | 0.25 |
| Pinna Leaf | 2.25 |
| Ethanol | 7 |
| Essential oil blend | 1 |
| Glycerin | 2.5 |
| Tego Solve | 2 |

In an implementation, the composition includes the following as shown in Table 9.

TABLE 9

| | Weight Percentage Total |
|---|---|
| Component | Composition (wt. %) |
| Water | 85 |
| Bio saponin | 0.1 |
| Pinna Leaf | 1.9 |
| Ethanol | 6 |
| Essential oil blend | 1 |
| Glycerin | 2.5 |
| Tego Solve | 3.5 |

In an implementation, the composition includes the following as shown in Table 10.

TABLE 10

| | Weight Percentage Total |
|---|---|
| Component | Composition (wt. %) |
| Water | 85 |
| Bio saponin | 0.25 |
| Pinna Leaf | 2.25 |
| Ethanol | 6 |
| Essential oil blend | 1 |
| Glycerin | 2.5 |
| Symbiosolv | 3 |

In an implementation, the composition includes the following as shown in Table 11.

TABLE 11

| | Weight Percentage Total |
|---|---|
| Component | Composition (wt. %) |
| Water | 86.25 |
| Bio saponin | 0.25 |
| Pinna Leaf | 1 |
| Ethanol | 6 |
| Essential oil blend | 1 |
| Glycerin | 2.5 |
| Symbiosolv | 3 |

In an implementation, the composition includes the following as shown in Table 12.

TABLE 12

| | Weight Percentage Total |
|---|---|
| Component | Composition (wt. %) |
| Water | 92.25 |
| Bio saponin | 0.25 |
| Pinna Leaf | 1 |
| Essential oil blend | 1 |
| Glycerin | 2.5 |
| Sunflower seedate | 3 |

In an implementation, the active ingredients of the essential oil blend include the following relative weight percentages as shown in Table 13.

TABLE 13

| Compound | Relative Area % of Essential Oil Blend |
|---|---|
| p-Cymene | 7.9% |
| 1,8-cineole | 16.0% |
| γ-Terpinene | 8.7% |
| Neral | 1.7% |
| Geranial | 2.9% |
| (E)-cinnamaldehyde | 6.4% |
| Thymol | 5.6% |
| Carvacrol | 15.5% |
| Eugenol | 21.7% |

In an implementation, the active ingredients of the essential oil blend include the following relative weight percentages as shown in Table 14.

TABLE 14

| Compound | Relative Area % of Essential Oil Blend |
|---|---|
| p-Cymene | 6% |
| 1,8-cineole | 18% |
| γ-Terpinene | 9% |
| Neral | 3% |
| Geranial | 4% |
| (E)-cinnamaldehyde | 6% |
| Thymol | 6% |
| Carvacrol | 16% |
| Eugenol | 23% |

In an implementation, the active ingredients of the essential oil blend include the following relative weight percentages as shown in Table 15.

TABLE 15

| Compound | Relative Area % of Essential Oil Blend |
|---|---|
| p-Cymene | 9% |
| 1,8-cineole | 15% |
| γ-Terpinene | 7% |
| Neral | 4% |
| Geranial | 4% |
| (E)-cinnamaldehyde | 8% |
| Thymol | 5% |
| Carvacrol | 20% |
| Eugenol | 25% |

FIG. 5 is a schematic flow chart diagram of a method 500 for preparing an essential oil-based fungicidal composition as described herein. The method 500 includes preparing at 502 a first composition part in an aqueous phase. The first composition part is mixed for a threshold duration of time such as 5 minutes, 10 minutes, or more. The method 500 includes preparing at 504 a second composition part that includes a solubilizer and an essential oil. The second composition part is mixed for a threshold duration of time such as 5 minutes, 10 minutes, or more. The method 500 includes combining at 506 the first composition part and the second composition part to generate a fungicidal composition. The fungicidal composition is mixed for a threshold duration of time such as 5 minutes, 10 minutes, or more.

As discussed in connection with FIG. 5, the essential oil-based fungicidal compositions described herein may be prepared in two phases. In this case, the final fungicidal composition is first prepared as separate first and second compositions. The first composition may include an aqueous composition that is mixed at a threshold speed for a threshold duration of time. In an example implementation, the first composition is mixed at 500 rpm for five minutes. The second composition may comprise a solubilizer and one or more essential oils. The second composition is also mixed at a threshold speed for a threshold duration of time. In an example implementation, the second composition is mixed manually with a glass stir rod for five minutes. The process may then include combining the first composition and the second composition to generate a final composition. The final composition may also be mixed at a threshold speed for a threshold duration of time. In an example implementation, the final composition is mixed at 500 rpm for five minutes.

The solubilizer may include one or more of a polysorbate, safflower oleosome, propanediol, calcium stearate, hydrogenated castor oil, polyvinyl pyrrolidone, vinylpyrrolidone excipient, Tegosolve®, Plantacare®, Natragem®, Sepiclear®, Symbiosolv®, sodium sunflowerseedate, and others.

### Examples

The following examples pertain to further embodiments.

Example 1 is a composition. The composition includes water, a solubilizer, and an essential oil extracted from one or more of lemongrass, cassia, eucalyptus, ajowan, clove leaf, or oregano.

Example 2 is a composition as in Example 1, wherein the composition comprises one or more of neral or geranial extracted from the lemongrass.

Example 3 is a composition as in any of Examples 1-2, wherein the composition comprises E-cinnamaldehyde extracted from the cassia.

Example 4 is a composition as in any of Examples 1-3, wherein the composition comprises 1,8-cineole extracted from the eucalyptus.

Example 5 is a composition as in any of Examples 1-4, wherein the composition comprises one or more of p-Cymene, γ-Terpinene, or Thymol extracted from the ajowan.

Example 6 is a composition as in any of Examples 1-5, wherein the composition comprises eugenol extracted from the clove leaf.

Example 7 is a composition as in any of Examples 1-6, wherein the composition comprises carvacrol extracted from the oregano.

Example 8 is a composition as in any of Examples 1-7, wherein the solubilizer comprises a surfactant.

Example 9 is a composition as in any of Examples 1-8, wherein the composition comprises an essential oil blend comprising each of: the essential oil extracted from the lemongrass; the essential oil extracted from the cassia; the essential oil extracted from the eucalyptus; the essential oil extracted from the ajowan; the essential oil extracted from the clove leaf; and the essential oil extracted from the oregano.

Example 10 is a composition as in any of Examples 1-9, wherein the essential oil comprises from about 0.5 wt. % to about 2 wt. % the composition.

Example 11 is a composition as in any of Examples 1-10, wherein the essential oil extracted from the ajowan comprises from about 5 wt. % to about 25 wt. % the essential oil blend.

Example 12 is a composition as in any of Examples 1-11, wherein the essential oil extracted from the eucalyptus comprises from about 5 wt. % to about 25 wt. % the essential oil blend.

Example 13 is a composition as in any of Examples 1-12, wherein the essential oil extracted from the lemongrass comprises from about 2 wt. % to about 10 wt. % the essential oil blend.

Example 14 is a composition as in any of Examples 1-13, wherein the essential oil extracted from the cassia comprises from about 4 wt. % to about 10 wt. % the essential oil blend.

Example 15 is a composition as in any of Examples 1-14, wherein the essential oil extracted from the oregano comprises from about 15 wt. % to about 35 wt. % the essential oil blend.

Example 16 is a composition as in any of Examples 1-15, wherein the essential oil extracted from the clove leaf comprises from about 18 wt. % to about 30 wt. % the essential oil blend.

Example 17 is a composition as in any of Examples 1-16, wherein the essential oil extracted from the ajowan comprises: p-Cymene in a concentration from about 6 wt. % to about 10 wt. % the essential oil blend; γ-Terpinene in a concentration from about 6 wt. % to about 11 wt. % the essential oil blend; and thymol in a concentration from about 4 wt. % abo to about 9 wt. % the essential oil blend.

Example 18 is a composition as in any of Examples 1-17, wherein the essential oil extracted from the lemongrass comprises: neral in a concentration from about 1 wt. % to about 4 wt. % the essential oil blend; and geranial in a concentration from about 1.5 wt. % to about 6 wt. % the essential oil blend.

Example 19 is a composition as in any of Examples 1-18, wherein the water comprises from about 75 wt. % to about 95 wt. % the composition.

Example 20 is a composition as in any of Examples 1-19, wherein the essential oil comprises a plurality of essential oils, and wherein the plurality of essential oils constitute the active ingredient of the composition that kills or inhibits the growth of the fungus.

Example 21 is a composition as in any of Examples 1-20, wherein the water of the composition is from about 65 wt. % to about 95 wt. % the total composition. The water may specifically constitute any of the following: from about 65 wt % to about 90 wt. % the total composition; from about 70 wt % to about 95 wt. % the total composition; from about 75 wt % to about 95 wt. % the total composition; from about 80 wt % to about 95 wt. % the total composition; from about 81 wt % to about 95 wt. % the total composition; from about 82 wt % to about 95 wt. % the total composition; from about 83 wt % to about 95 wt. % the total composition; from about 84 wt % to about 95 wt. % the total composition; from about 85 wt % to about 95 wt. % the total composition; from about 85 wt % to about 94 wt. % the total composition; from about 85 wt % to about 93 wt. % the total composition; from about 85 wt % to about 92 wt. % the total composition; from about 85 wt % to about 91 wt. % the total composition; from about 85 wt % to about 90 wt. % the total composition.

Example 22 is a composition as in any of Examples 1-21, wherein the solubilizer of the composition is from about 1 wt. % to about 8 wt. % the total composition. The solubilizer may specifically constitute any of the following: from about 1 wt. % to about 7 wt. % the total composition; from about 1 wt. % to about 6 wt. % the total composition; from about 1 wt. % to about 5 wt. % the total composition; from about 2 wt. % to about 5 wt. % the total composition; from about 3 wt. % to about 5 wt. % the total composition.

Example 23 is a composition as in any of Examples 1-22, wherein the essential oil is an essential oil blend comprising a plurality of essential oils, and wherein the essential oil blend comprises from about 0.25 wt. % to about 5 wt. % the total composition. The essential oil may specifically constitute any of the following: from about 0.5 wt. % to about 5 wt. % the total composition; from about 0.5 wt. % to about 4 wt. % the total composition; from about 0.5 wt. % to about 3 wt. % the total composition; from about 0.5 wt. % to about 2.5 wt. % the total composition; from about 0.75 wt. % to about 2.5 wt. % the total composition; from about 1 wt. % to about 2.5 wt. % the total composition; or from about 0.5 wt. % to about 2 wt. % the total composition.

Example 24 is a composition as in any of Examples 1-23, wherein the essential oil blend comprises p-cymene in a concentration from about 4 wt. % to about 12 wt. % the total essential oil blend. The p-cymene may specifically constitute any of the following: from about 4 wt. % to about 11 wt. % the total essential oil blend; from about 4 wt. % to about 10 wt. % the total essential oil blend; from about 4 wt. % to about 9 wt. % the total essential oil blend; from about 5 wt. % to about 12 wt. % the total essential oil blend; from about 5 wt. % to about 11 wt. % the total essential oil blend; from about 6 wt. % to about 11 wt. % the total essential oil blend; from about 7 wt. % to about 11 wt. % the total essential oil blend; from about 7 wt. % to about 10 wt. % the total essential oil blend; or from about 7 wt. % to about 9 wt. % the total essential oil blend.

Example 25 is a composition as in any of Examples 1-24, wherein the essential oil blend comprises γ-Terpinene in a concentration from about 4 wt. % to about 12 wt. % the total essential oil blend. The γ-Terpinene may specifically constitute any of the following: from about 4 wt. % to about 11 wt. % the total essential oil blend; from about 4 wt. % to about 10 wt. % the total essential oil blend; from about 4 wt. % to about 9 wt. % the total essential oil blend; from about 5 wt. % to about 12 wt. % the total essential oil blend; from about 5 wt. % to about 11 wt. % the total essential oil blend; from about 6 wt. % to about 11 wt. % the total essential oil blend; from about 7 wt. % to about 11 wt. % the total essential oil blend; from about 7 wt. % to about 10 wt. % the total essential oil blend; or from about 7 wt. % to about 9 wt. % the total essential oil blend.

Example 26 is a composition as in any of Examples 1-25, wherein the essential oil blend comprises 1,8-cineole in a concentration from about 10 wt. % to about 24 wt. % the total essential oil blend. The 1,8-cineole may specifically constitute any of the following: from about 10 wt. % to about 23 wt. % the total essential oil blend; from about 10 wt. % to about 22 wt. % the total essential oil blend; from about 10 wt. % to about 21 wt. % the total essential oil blend; from about 10 wt. % to about 20 wt. % the total essential oil blend; from about 10 wt. % to about 19 wt. % the total essential oil blend; from about 10 wt. % to about 18 wt. % the total essential oil blend; from about 11 wt. % to about 23 wt. % the total essential oil blend; from about 12 wt. % to about 23 wt. % the total essential oil blend; from about 13 wt. % to about 23 wt. % the total essential oil blend; from about 14 wt. % to about 23 wt. % the total essential oil blend; from about 14 wt. % to about 22 wt. % the total essential oil blend; from about 14 wt. % to about 21 wt. % the total essential oil blend; from about 14 wt. % to about 20 wt. % the total essential oil blend; from about 14 wt. % to about 19 wt. % the total essential oil blend; or from about 14 wt. % to about 18 wt. % the total essential oil blend.

Example 27 is a composition as in any of Examples 1-26, wherein the essential oil blend comprises carvacrol in a concentration from about 10 wt. % to about 24 wt. % the total essential oil blend. The carvacrol may specifically constitute any of the following: from about 10 wt. % to about 23 wt. % the total essential oil blend; from about 10 wt. % to about 22 wt. % the total essential oil blend; from about 10 wt. % to about 21 wt. % the total essential oil blend; from about 10 wt. % to about 20 wt. % the total essential oil blend; from about 10 wt. % to about 19 wt. % the total essential oil blend; from about 10 wt. % to about 18 wt. % the total essential oil blend; from about 11 wt. % to about 23 wt. % the total essential oil blend; from about 12 wt. % to about 23 wt. % the total essential oil blend; from about 13 wt. % to about 23 wt. % the total essential oil blend; from about 14 wt. % to about 23 wt. % the total essential oil blend; from about 14 wt. % to about 22 wt. % the total essential oil blend; from about 14 wt. % to about 21 wt. % the total essential oil blend; from about 14 wt. % to about 20 wt. % the total essential oil blend; from about 14 wt. % to about 19 wt. % the total essential oil blend; or from about 14 wt. % to about 18 wt. % the total essential oil blend.

Example 28 is a composition as in any of Examples 1-27, wherein the essential oil blend comprises neral in a concentration from about 0.2 wt. % to about 6 wt. % the total essential oil blend. The neral may specifically constitute any of the following: from about 0.2 wt. % to about 5 wt. % the total essential oil blend; from about 0.4 wt. % to about 5 wt. % the total essential oil blend; from about 0.6 wt. % to about 5 wt. % the total essential oil blend; from about 0.8 wt. % to about 5 wt. % the total essential oil blend; from about 1 wt. % to about 5 wt. % the total essential oil blend; from about 1 wt. % to about 4 wt. % the total essential oil blend; or from about 1 wt. % to about 3 wt. % the total essential oil blend.

Example 29 is a composition as in any of Examples 1-28, wherein the essential oil blend comprises geranial in a concentration from about 0.2 wt. % to about 6 wt. % the total essential oil blend. The geranial may specifically constitute any of the following: from about 0.2 wt. % to about 5 wt. % the total essential oil blend; from about 0.4 wt. % to about 5 wt. % the total essential oil blend; from about 0.6 wt. % to about 5 wt. % the total essential oil blend; from about 0.8 wt. % to about 5 wt. % the total essential oil blend; from about 1 wt. % to about 5 wt. % the total essential oil blend; from about 1 wt. % to about 4 wt. % the total essential oil blend; or from about 1 wt. % to about 3 wt. % the total essential oil blend.

Example 30 is a composition as in any of Examples 1-29, wherein the essential oil blend comprises (E)-cinnamaldehyde in a concentration from about 2 wt. % to about 13 wt. % the total essential oil blend. The (E)-cinnamaldehyde may specifically constitute any of the following: from about 2 wt. % to about 12 wt. % the total essential oil blend; from about 2 wt. % to about 11 wt. % the total essential oil blend; from about 2 wt. % to about 10 wt. % the total essential oil blend; from about 2 wt. % to about 9 wt. % the total essential oil blend; from about 2 wt. % to about 8 wt. % the total essential oil blend; from about 3 wt. % to about 12 wt. % the total essential oil blend; from about 4 wt. % to about 12 wt. % the total essential oil blend; from about 4 wt. % to about 10 wt. % the total essential oil blend; or from about 4 wt. % to about 8 wt. % the total essential oil blend.

Example 31 is a composition as in any of Examples 1-30, wherein the essential oil blend comprises thymol in a concentration from about 2 wt. % to about 13 wt. % the total essential oil blend. The thymol may specifically constitute any of the following: from about 2 wt. % to about 12 wt. % the total essential oil blend; from about 2 wt. % to about 11 wt. % the total essential oil blend; from about 2 wt. % to about 10 wt. % the total essential oil blend; from about 2 wt. % to about 9 wt. % the total essential oil blend; from about 2 wt. % to about 8 wt. % the total essential oil blend; from about 3 wt. % to about 12 wt. % the total essential oil blend; from about 4 wt. % to about 12 wt. % the total essential oil blend; from about 4 wt. % to about 10 wt. % the total essential oil blend; or from about 4 wt. % to about 8 wt. % the total essential oil blend.

Example 32 is a composition as in any of Examples 1-31, wherein the essential oil blend comprises eugenol in a concentration from about 10 wt. % to about 30 wt. % the total essential oil blend. The eugenol may specifically constitute any of the following: from about 10 wt. % to about 29 wt. % the total essential oil blend; from about 10 wt. % to about 28 wt. % the total essential oil blend; from about 10 wt. % to about 27 wt. % the total essential oil blend; from about 10 wt. % to about 26 wt. % the total essential oil blend; from about 10 wt. % to about 25 wt. % the total essential oil blend; from about 10 wt. % to about 24 wt. % the total essential oil blend; from about 11 wt. % to about 24 wt. % the total essential oil blend; from about 12 wt. % to about 24 wt. % the total essential oil blend; from about 13 wt. % to about 24 wt. % the total essential oil blend; from about 14 wt. % to about 24 wt. % the total essential oil blend; from about 15 wt. % to about 24 wt. % the total essential oil blend; from about 16 wt. % to about 24 wt. % the total essential oil blend; from about 17 wt. % to about 24 wt. % the total essential oil blend; from about 17 wt. % to about 23 wt. % the total essential oil blend; or from about 18 wt. % to about 23 wt. % the total essential oil blend.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A fungicidal composition that kills or inhibits growth of a fungus, the composition comprising:
water;
a solubilizer; and
an essential oil extracted from one or more of lemongrass, cassia, eucalyptus, ajowan, clove leaf, or oregano.

2. The composition of claim 1, wherein the composition comprises one or more of neral or geranial extracted from the lemongrass.

3. The composition of claim 1, wherein the composition comprises E-cinnamaldehyde extracted from the cassia.

4. The composition of claim 1, wherein the composition comprises 1,8-cineole extracted from the eucalyptus.

5. The composition of claim 1, wherein the composition comprises one or more of p-Cymene, γ-Terpinene, or Thymol extracted from the ajowan.

6. The composition of claim 1, wherein the composition comprises eugenol extracted from the clove leaf.

7. The composition of claim 1, wherein the composition comprises carvacrol extracted from the oregano.

8. The composition of claim 1, wherein the solubilizer comprises a surfactant.

9. The composition of claim 1, wherein the composition comprises an essential oil blend comprising each of:
the essential oil extracted from the lemongrass;
the essential oil extracted from the cassia;
the essential oil extracted from the eucalyptus;
the essential oil extracted from the ajowan;
the essential oil extracted from the clove leaf; and
the essential oil extracted from the oregano.

10. The composition of claim 9, wherein the essential oil comprises from about 0.5 wt. % to about 2 wt. % the composition.

11. The composition of claim 10, wherein the essential oil extracted from the ajowan comprises from about 5 wt. % to about 25 wt. % the essential oil blend.

12. The composition of claim 10, wherein the essential oil extracted from the eucalyptus comprises from about 5 wt. % to about 25 wt. % the essential oil blend.

13. The composition of claim 10, wherein the essential oil extracted from the lemongrass comprises from about 2 wt. % to about 10 wt. % the essential oil blend.

14. The composition of claim 10, wherein the essential oil extracted from the cassia comprises from about 4 wt. % to about 10 wt. % the essential oil blend.

15. The composition of claim 10, wherein the essential oil extracted from the oregano comprises from about 15 wt. % to about 35 wt. % the essential oil blend.

16. The composition of claim 10, wherein the essential oil extracted from the clove leaf comprises from about 18 wt. % to about 30 wt. % the essential oil blend.

17. The composition of claim 10, wherein the essential oil extracted from the ajowan comprises:
p-Cymene in a concentration from about 6 wt. % to about 10 wt. % the essential oil blend;
γ-Terpinene in a concentration from about 6 wt. % to about 11 wt. % the essential oil blend; and
thymol in a concentration from about 4 wt. % abo to about 9 wt. % the essential oil blend.

18. The composition of claim 10, wherein the essential oil extracted from the lemongrass comprises:
neral in a concentration from about 1 wt. % to about 4 wt. % the essential oil blend; and
geranial in a concentration from about 1.5 wt. % to about 6 wt. % the essential oil blend.

19. The composition of claim 1, wherein the water comprises from about 75 wt. % to about 95 wt. % the composition.

20. The composition of claim 1, wherein the essential oil comprises a plurality of essential oils, and wherein the plurality of essential oils constitute the active ingredient of the composition that kills or inhibits the growth of the fungus.
